(19) United States
(12) Patent Application Publication
(10) Pub. No.: US 2008/0095534 A1
(43) Pub. Date: Apr. 24, 2008

(54) Method for Operating a Telecommunications Access Network

(76) Inventor: Pierpaolo Ghiggino, Warwickshire (GB)

Correspondence Address: COATS & BENNETT, PLLC, 1400 Crescent Green, Suite 300, Cary, NC, 27518, US

(21) Appl. No.: 11/575,049

(22) PCT Filed: Sep. 1, 2005
(86) PCT No.: PCT/EP05/54312

§ 371 Date: Jul. 19, 2007

(30) Foreign Application Priority Data
Sep. 10, 2004 (GB) 0420127.3

(51) Int. Cl. H04J 14/00; H04B 10/20

(52) U.S. Cl. 398/58

(57) ABSTRACT

The invention relates to telecommunications network (10), and in particular to a Passive Optical Network (PON), and a method for operation thereof. The telecommunications network (10, 60) is capable of handling increases in bandwidth per user over the predicted lifetime of the network infrastructure. The telecommunications network (10, 60) further utilises a greater proportion of the potential bandwidth carrying capacity of the network and minimises maintenance requirements. The network (10, 60) is readily adaptable to future bandwidth requirements because redundant optic fibres (18, 27) are provided for making more connections as required. The cost of laying redundant optic fibres (18, 27) is minimal when compared to the cost of laying additional optic fibres at a later date. Furthermore the cost of maintaining the network is kept to a minimum because of the use of PON technology and consequently the overall cost of installing and maintaining the network over a predicted lifetime of 20 years is reduced.

The present invention relates to a telecommunications network, and in particular to a Passive Optical Network (PON), and a method for operation thereof.

A telecommunications network such as an optical telecommunications network can be expensive to install and maintain. A typical optical network such as a metropolitan area network with 4500 users might cost over £200M to initially deploy with further ongoing maintenance and upgrade costs. Optic fibres of the network are typically required to be buried underground which involves costly excavation of roads also causing disruption. Expense and further disruption is caused when routing cabling and optic fibres to a user's premises.

Currently each residential user of a telecommunications network has an average data carrying requirement of up to 516 kb/s, and a typical small to medium sized business has a requirement of up to 8 Mb/s. Based on the current rate of increase these future bandwidth requirement may eventually increase to 1 Gb/s per residential user, and 10 Gb/s per small to medium sized business, over the next 20 years.

It is known to use a PON using standards such as A-PON, B-PON, E-PON and G-PON to supply users with the current required level of bandwidth. A typical PON comprises an optical splitter near the communication company's premises and a series of Optical Network Units (ONUs) near the end users. In such a PON a series of 12 optical splitters are provided, each optical splitter supplying 16 ONUs which in turn are each connected to 24 users. Such a PON can serve up to 12×16×24=4608 users with an average bandwidth of 50-100 Mb/s per user. A PON is considered to be passive because the optical transmission through the network has no power requirements, and there are no active electronic parts for optical amplification purposes once an optical signal is travelling through the network. For example, such a PON is based on passive optical splitters and fibres with the intention of avoiding active devices and network elements other than in central office locations and in the customer premises. This has the advantage of a very low maintenance cost which can lead to large operational expenditure saving

One of the problems associated with the known PON is that each splitting level reduces the optical power in each branch by 3 dB. Such a reduction in power inherently limits the bandwidth carrying capacity and in particular the bandwidth-distance product. The reduction in optical power and the standards that regulate the use of the known PON results in a poor utilisation of the potential bandwidth carrying capacity. Such inefficiencies may result in only 1% of the potential bandwidth carrying capacity of the PON being utilised.

A further problem associated with deploying a PON is the initial cost of the fibre infrastructure versus the ability of the PON to be upgraded over time to handle an increase of bandwidth per user. Such an increase in bandwidth may require replacement of existing optic fibres or deployment of new optic fibres which involves the costly excavation of roads and the routing of cabling and optic fibres to the user's premises.

What is required is a telecommunications network that is capable of handling increases in bandwidth per user over the predicted lifetime of the network infrastructure whilst minimising the requirement for optic fibres to be replaced or added. The telecommunications network should further utilise a greater proportion of the potential bandwidth carrying capacity of the network and should also have minimal maintenance requirements. Furthermore, such a fibre-based infrastructure should also be able to support future mobile networks.

According to a first aspect of the invention there is provided a method of operating a passive optical network comprising the steps of;
providing a feed optic fibre bundle in communication with a wavelength division multiplexing optical network;
providing an optical splitter in communication with an optic fibre in the feed optic fibre bundle;
providing a connecting optic fibre in communication with the optic splitter;
providing an optical network unit in communication with the connecting optic fibre; and
providing a supply optic fibre in communication with the optical network unit, the supply optic fibre being adapted for communication with a user of the network,
   wherein the feed optic fibre bundle has a plurality of redundant optic fibres.

Such a network is readily adaptable to future bandwidth requirements because the redundant optic fibres in the feed optic fibre bundle can be used at a later time to make more connections as required. The cost of laying redundant optic fibres is minimal when compared to the cost of laying additional optic fibres at a later date. Furthermore the cost of maintaining the network is kept to a minimum because of the use of PON technology. An advantage of using PON technology is that because it is passive it allows the communication of greater bandwidth over greater distance whilst minimising the requirement for active amplification sites. The network requires minimal maintenance due to the lack of such optical amplification sites. It is envisaged that the network could be used for 4 product lifecycles of associated optoelectronics which may be up to 20 years after installation of the network. The fixed sites of the network such as the optical splitter and the optical network unit are readily upgradeable whereas the redundant optic fibres can be used as necessary without the requirement for additional road excavation. Consequently the overall cost of installing and maintaining the network over a predicted lifetime of 20 years is reduced.

In a preferred embodiment the method further includes the step of;
providing a connecting optic fibre bundle, the connecting optic fibre comprising an optic fibre in the connecting optic fibre bundle.

Such a connecting optic fibre bundle further improves the upgradeability of the network in the future whereby the redundant fibres in the connecting optic fibre bundle can be used over time as required.

Preferably the method further includes the step of providing a plurality of supply optic fibres, one supply optic fibre for each user of the network, wherein each supply optic fibre is connected to the optical network unit.

Such an arrangement of providing feed optic fibres, connecting optic fibres and supply optic fibres utilises a star topology of the network. Such a topology provides for readily upgradeability of the network over time.

In a preferred embodiment the method further includes the step of reducing the number of users per optical network unit over time to enable an increased bandwidth per user to be provided over time.

Such an arrangement is possible due to the topology of the network. Since the redundant feed optic fibres, the redundant connecting optic fibres and the supply optic fibres are already in place the additional bandwidth can be achieved by providing additional optical network units and additional optical splitters as required. Connections of optic fibres to the additional optical network units and optical splitters are made at the location of the existing optical network units and optical splitters.

The method may further include the step of providing a copper cable in communication with the optical network unit wherein the copper cable is connected with a user of the network.

Such an arrangement permits the coexistence of optic fibre and copper cable as the network is gradually upgraded into an entirely optic fibre architecture.

The method may include the step of providing a plurality of copper cables, one copper cable for each user of the network wherein each copper cable is connected to the optical network unit.

Preferably the method further includes the step of replacing the copper cables with optic fibres. Such a step represents an upgrading step of the network whereby the network architecture is changed into being primarily optic fibre based.

In a preferred embodiment the method further includes the step of;
providing a user connection terminal at the location of each user of the network to permit the user to connect to the network by optic fibre, in use.

Preferably the method includes the step of at least partially leasing the user connection terminal to each user.

The terminal is intended to bring the optic fibre connection directly into the user's premises to maximize bandwidth carrying capacity to the user.

The method may further include the step of arranging the network as a plurality of cells, wherein each cell is supplied with a respective feed optic fibre bundle.

Such a plurality of cells provides for ready visibility of users of the network and provides a convenient way of operating the network. Nominally each cell represents 384 users of the network.

Preferable the method includes the step of providing nine cells in the passive optical network.

In one embodiment the optic fibre bundles contain up to 12 optic fibres although as many as 200 optic fibres may be included.

According to a second aspect of the invention there is provided a passive optical network comprising a feed optic fibre bundle in communication with a wavelength division multiplexing optical network, an optical splitter in communication with an optic fibre in the feed optic fibre bundle, a connecting optic fibre in communication with the optic splitter, an optical network unit in communication with the connecting optic fibre, and a supply optic fibre in communication with the optical network unit, the supply optic fibre being adapted for communication with a user of the network, wherein the feed optic fibre bundle has a plurality of redundant optic fibres.

Such a network is readily adaptable and upgradeable to future bandwidth requirements because of the redundant optic fibres in the feed optic fibre bundle, which can be used to supply greater bandwidth.

In a preferred embodiment the network further includes a connecting optic fibre bundle, the connecting optic fibre comprising an optic fibre in the connecting optic fibre bundle.

Such a connecting optic fibre bundle further improves the future upgradeability of the network whereby the redundant fibres in the connecting optic fibre bundle can be used in future upgrades of the network as required.

Preferably a plurality of supply optic fibres are provided, one feed optic fibre for each user of the network, wherein each feed optic fibre is connected to the optical network unit.

Such an arrangement of providing feed optic fibres, connecting optic fibres and supply optic fibres utilises a star topology which provides for readily upgradeability of the network over time.

The redundant feed optic fibres, the redundant connecting optic fibres and the supply optic fibres which are in place from the time of installation of the network provide for increases in bandwidth over time by adding further optical network units and optical splitters as required.

The network may further include a copper cable in communication with the optical network unit wherein the copper cable is in connection with a user of the network.

Such an arrangement permits the coexistence of optic fibre and a copper cable as the network is gradually upgraded into being a primarily optic fibre architecture.

The network may include a plurality of copper cables, one copper cable for each user of the network wherein each copper cable is connected to the optical network unit.

The network may be arranged as a plurality of cells, wherein each cell is supplied with a respective feed optic fibre bundle.

Preferable the passive optical network comprises nine cells.

In one embodiment the optic fibre bundles contains up to 12 optic fibres although as many as 200 optic fibres may be included.

In a preferred embodiment the network includes a user connection terminal at the location of each user of the network for connection to the network by optic fibre. Such a user connection terminal brings the optic fibre directly into each user's premises.

In one embodiment the respective supply optic fibre handles both inflow and outflow of data to the terminal.

In a preferred embodiment the terminal is provided with an input optic fibre and an output optic fibre for inflow and outflow of data to the terminal respectively, the input optic fibre and output optic fibre in communication with the optical network unit. Utilisation of such an optic fibre pair may minimise the cost of the overall fibre architecture of the network.

In a preferred embodiment the user connection terminal comprises a receiver in communication with the input optic fibre, the receiver being adapted for translating an input optical signal into an electrical signal, the electrical signal being input to a user commodity unit in use which in turn is adapted to communicate with an optical modulator for translation of the electrical signal into an output optical signal for transmission via the output optic fibre, wherein a user interacts with the terminal via said user commodity unit.

In a preferred embodiment the electrical signal is a radio frequency electric signal.

Preferably the commodity unit is primarily Ethernet based and may be adaptable for use with any of copper wire, optic fibre, radio, infra-red, mobile phone or other wireless access technologies.

Preferably the terminal is powered locally at the user's premises.

According to a third aspect of the present invention there is provided a method of operating a telecommunications network comprising the steps of;
providing a primary point of presence of a wavelength division multiplexing optical network;
providing a secondary point of presence in communication with the primary point of presence via a single fibre of a feed optic fibre bundle;
providing a passive optical network downstream of the secondary point of presence; and
providing a copper cable connection downstream of the secondary point of presence,
   wherein access to the network is provided via said passive optical network and via said copper cable.

In such an arrangement the secondary point of presence acts as a hybrid access point for users of the network such that access is provided by either copper wire or via the passive optical network downstream of the secondary point of presence. In this specification the term downstream means towards the user and accordingly the term upstream means towards the primary point of presence. Provision of the redundant optic fibres in the optic fibre bundle allows for upgrading of the network over time as required.

Preferably the method further includes the step of;
providing a wavelength division multiplexing demultiplexer downstream of the secondary point of presence such that the passive optical network is downstream of the wavelength division multiplexing demultiplexer, and
providing an optical network unit downstream of the wavelength division multiplexing demultiplexer,
   wherein the optical network unit is connected to users via a plurality of respective supply optical fibres.

Preferably a plurality of passive optical networks are provided downstream of the secondary point of presence.

In a preferred embodiment the method further including the steps of;
providing each passive optical network with at least one optical network unit; and
configuring the at least one optical network unit to operate using sub-carrier multiplexing.

Sub-carrier multiplexing provides the necessary privacy to permit each user to have a unique point to point connection whilst increasing the bandwidth-distance product. Since the bandwidth-distance product is increased the number of central offices containing equipment of the network can be reduced which in turn reduces the operational and capital expenditure of the network.

In a preferred embodiment the method further includes the step of bypassing the secondary point of presence with a splice optic fibre so that at least one of the passive optical networks downstream of the splice is backhauled to a respective feed optic fibre of the feed optic fibre bundle.

Such a step is achieved using the multiple redundant optic fibres in the feed optic fibre bundle and is a requirement of the network as the network architecture is gradually changed from being a combination of copper wire and optic fibre into being primarily optic fibre based.

In a preferred embodiment the method further includes the step of decommissioning the secondary point of presence and the copper cable connection. This step represents a significant reduction in the overall amount of equipment within the network such as the secondary point of presence and provides a consequent reduction in the operational and capital costs of the network.

According to a fourth aspect of the present invention there is provided a user connection terminal provided with an optic fibre for inflow and outflow of data, the terminal comprising a receiver in communication with the optic fibre, the receiver being adapted for translating an input optical signal into an electrical signal, the electrical signal being input to a user commodity unit, in use, which in turn is adapted to transmit an output electrical signal to an optical modulator for translation of the output electrical signal into an output optical signal for transmission via the optic fibre, wherein a user interacts with the terminal via said user commodity unit.

In a preferred embodiment there is provided an input optic fibre and an output optic fibre for inflow and outflow of data respectively, the receiver in communication with the input optic fibre, and the output optic fibre in communication with the optical modulator.

In a preferred embodiment the electrical signals are radio frequency electric signals.

Preferable the input electrical signal is passed to an input radio frequency mixer which is tuned to a sub-carrier frequency using a programmable oscillator. The particular frequency to which the input radio frequency mixer is tuned is allocated to a particular user by the network operator.

Preferably the input radio frequency mixer outputs to an interface which in turn communicates with the user commodity unit.

Communication between the interface and the user commodity unit may be via any of copper wire, optic fibre, radio, infra-red, mobile phone or other wireless access technologies.

In a preferred embodiment the user commodity unit is adapted for use with the Ethernet protocol.

In a preferred embodiment the interface communicates with an output radio frequency mixer which is tuned to the same frequency as the input radio frequency mixer by the programmable oscillator.

In a preferred embodiment the output radio frequency mixer communicates with the optical modulator.

Preferably the programmable oscillator is in two-way communication with a microprocessor which is in turn in two-way communication with a service and communication channel which in turn outputs to the optical modulator.

Such a service and communication channel permits the network operator to determine faults with the terminal or user commodity unit, or to determine whether the terminal has been tampered with.

Preferably the terminal is powered locally at the user's premises.

Preferably there is provided a sub-module which corresponds to the user connection terminal, wherein the sub-module is located at a point of presence. The sub-module is configured to communicate with the user connection terminal to permit a user to connect to the network.

In a preferred embodiment the sub-module is provided with an optic fibre for inflow and outflow of data to the sub-module, the sub-module comprising a sub-module receiver to translate an incoming optical signal into an input electrical signal, the input electrical signal being input to a sub-module commodity unit, the sub-module commodity unit communicating, in use, with the upstream network, data flowing downstream from the sub-module commodity unit being translated into an output electrical signal and being input to a sub-module optical modulator for translation into an output optical signal for transmission via the optic fibre.

In a preferred embodiment there is provided an input optic fibre and an output optic fibre for inflow and outflow of data respectively, the sub-module receiver in communication with the input optic fibre, and the output optic fibre in communication with the sub-module optical modulator.

In a preferred embodiment the electrical signals are radio frequency electric signals.

Preferable the input electrical signal is input to an input radio frequency mixer which is tuned by a sub-module programmable oscillator to the same sub-carrier frequency as the user connection terminal.

Preferably the input radio frequency mixer is in communication with the sub-module commodity unit.

In a preferred embodiment the sub-module commodity unit communicates with an output radio frequency mixer which is tuned to the same frequency as the input radio frequency mixer by the sub-module programmable oscillator.

In a preferred embodiment the output radio frequency mixer outputs to the sub-module optical modulator.

Preferably the sub-module programmable oscillator is in two-way communication with a sub-module microprocessor which is in turn in two-way communication with the service and communication channel which in turn outputs to the sub-module optical modulator.

Other features of the invention will be apparent from the following description of a preferred embodiment shown by way of example only in the accompanying drawings, in which;

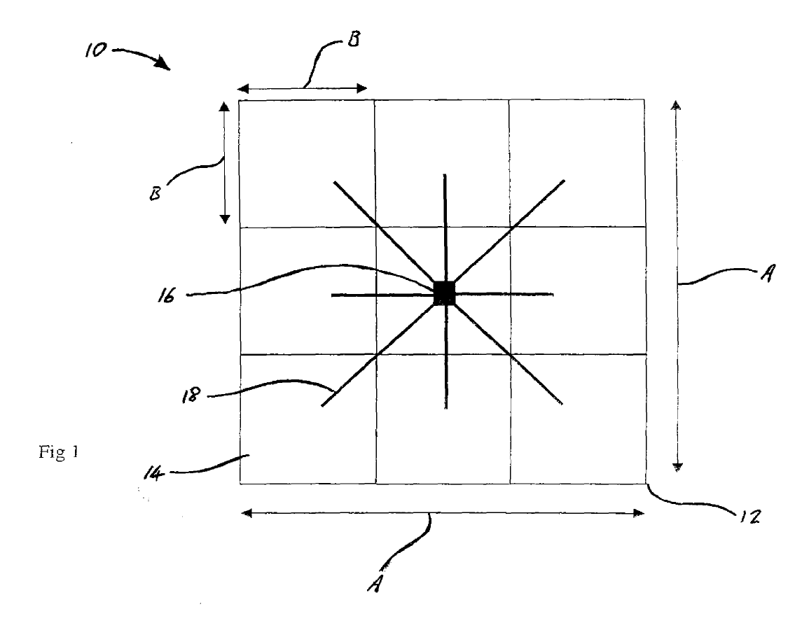

FIG. 1 is a diagrammatic representation of a telecommunications network in a first stage according to an aspect of the present invention.

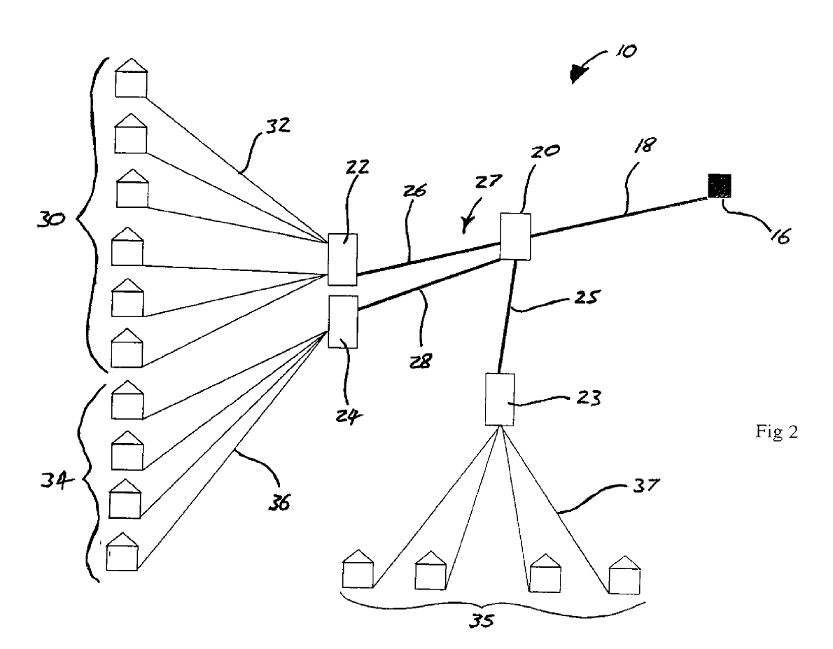

FIG. 2 is a detailed diagrammatic representation of a part of the network of FIG. 1 in the first stage.

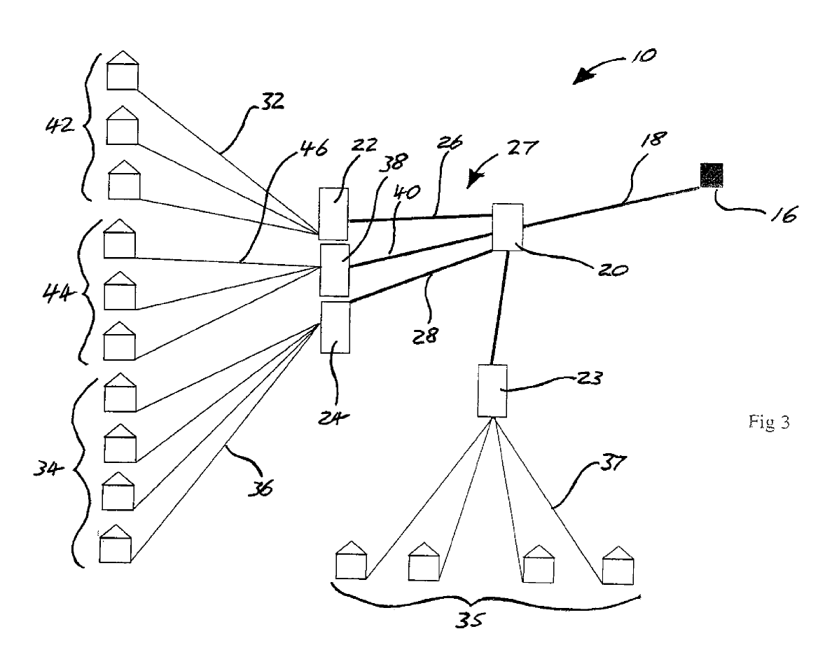

FIG. 3 is a detailed diagrammatic representation of a part of the network of FIG. 2 in a second stage.

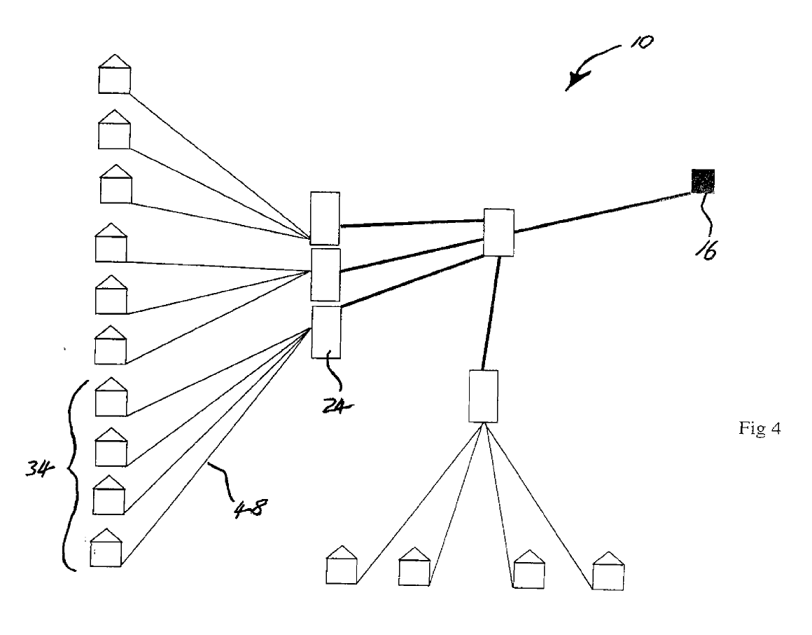

FIG. 4 is a detailed diagrammatic representation of a part of the network of FIG. 3 in a third stage.

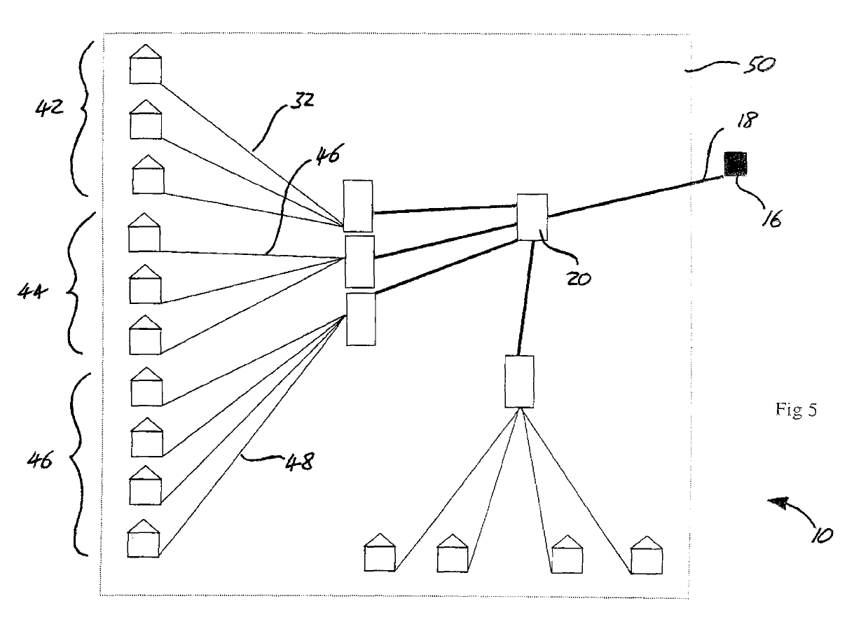

FIG. 5 is a detailed diagrammatic representation of a part of the network of FIG. 4 in a fourth stage.

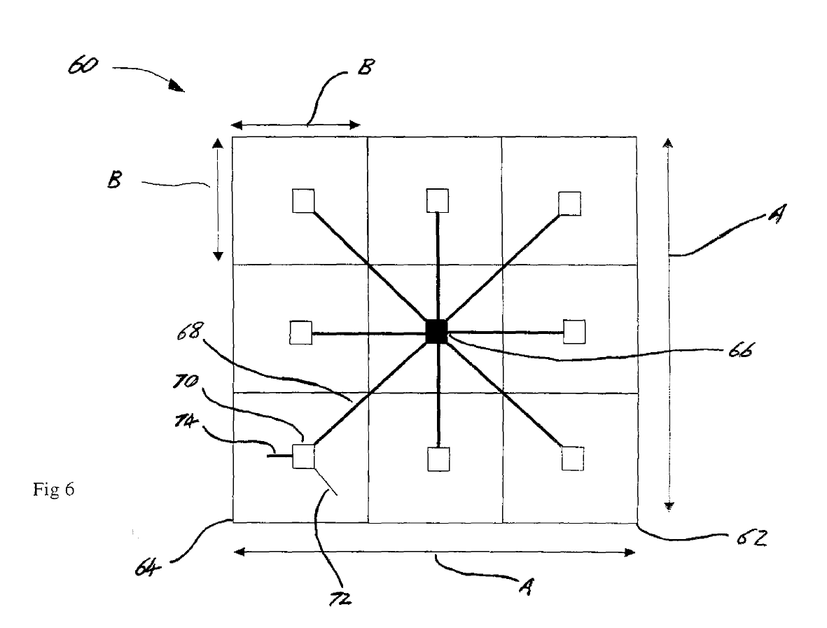

FIG. 6 is a diagrammatic representation of a telecommunications network according to a further aspect of the present invention in a first stage.

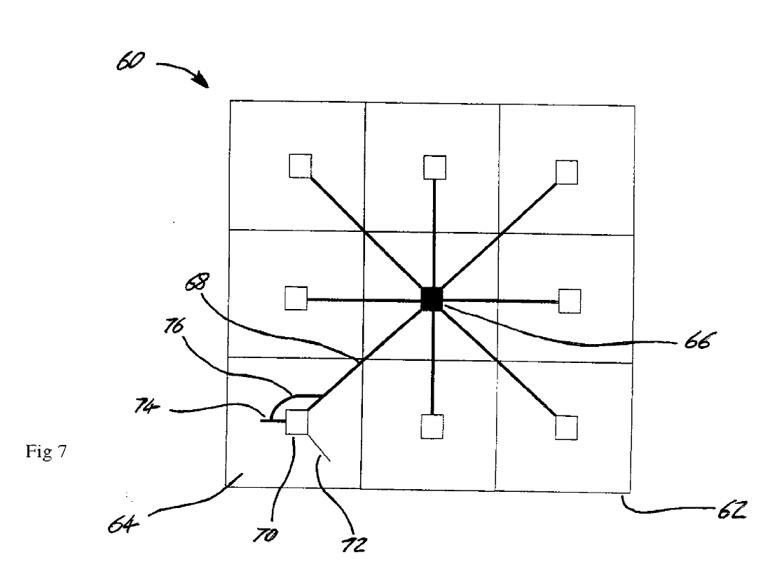

FIG. 7 is a diagrammatic representation of the network of FIG. 6 in a second stage.

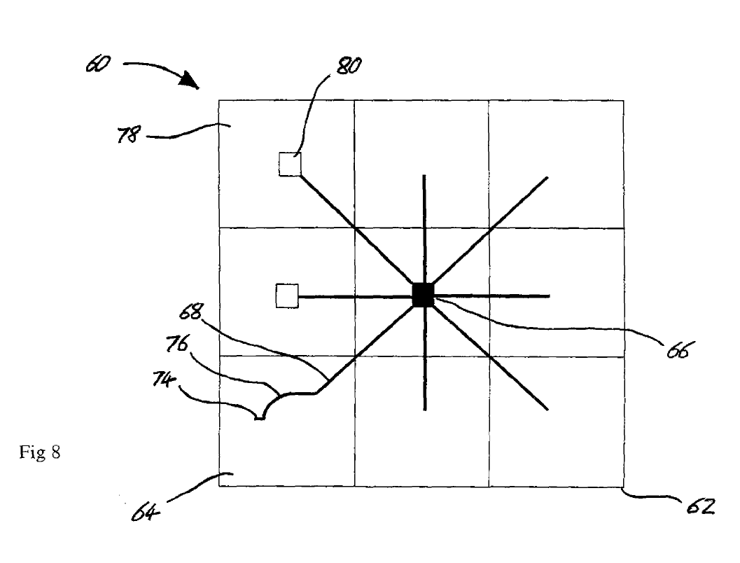

FIG. 8 is a diagrammatic representation of the network of FIG. 7 in a third stage.

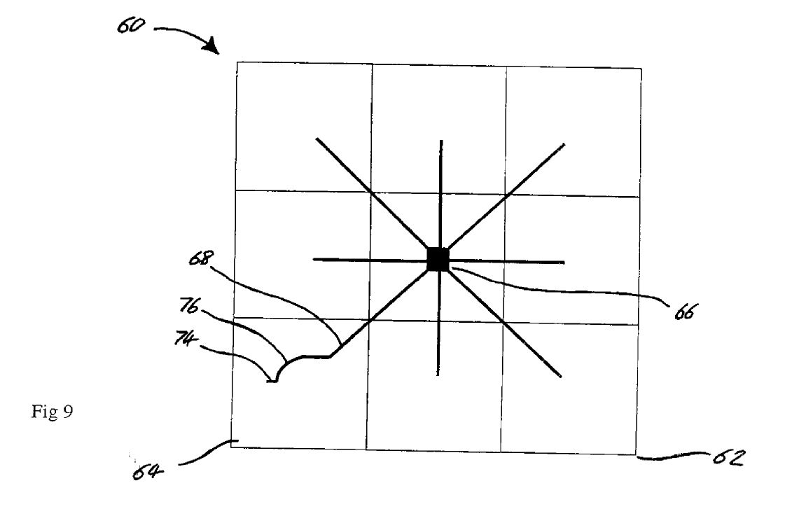

FIG. 9 is a diagrammatic representation of the network of FIG. 8 in a fourth stage.

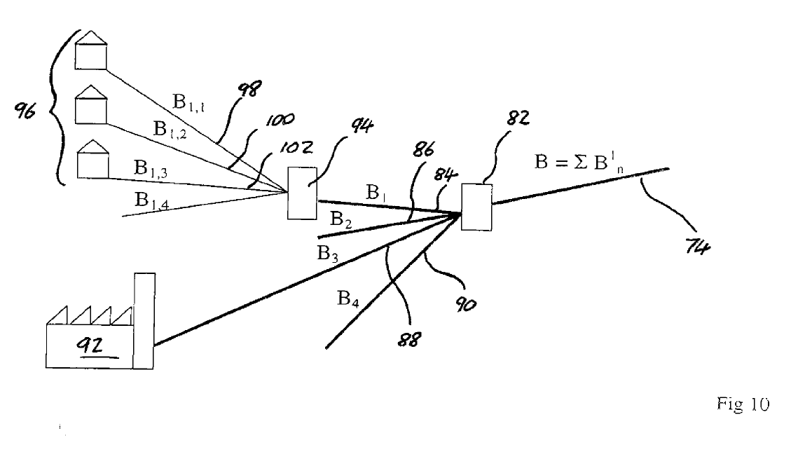

FIG. 10 is a diagrammatic representation of a part of the network of FIG. 9.

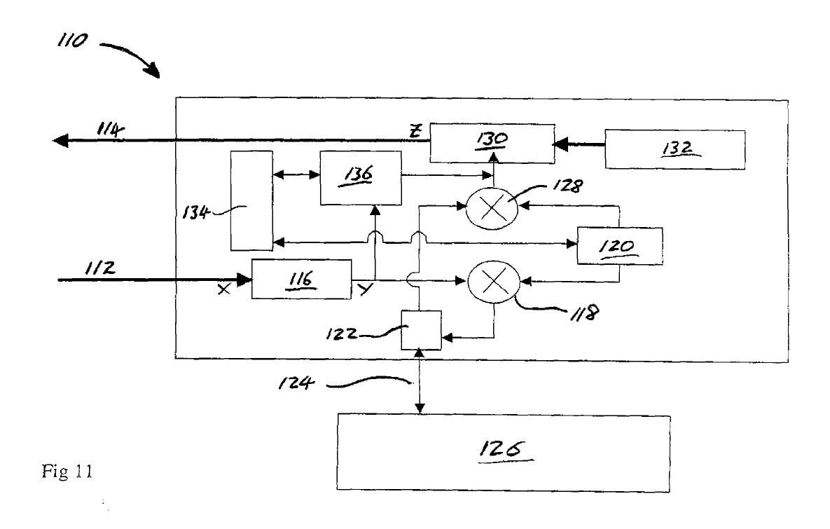

FIG. 11 shows a diagrammatic representation of a user connection terminal according to a further aspect of the present invention

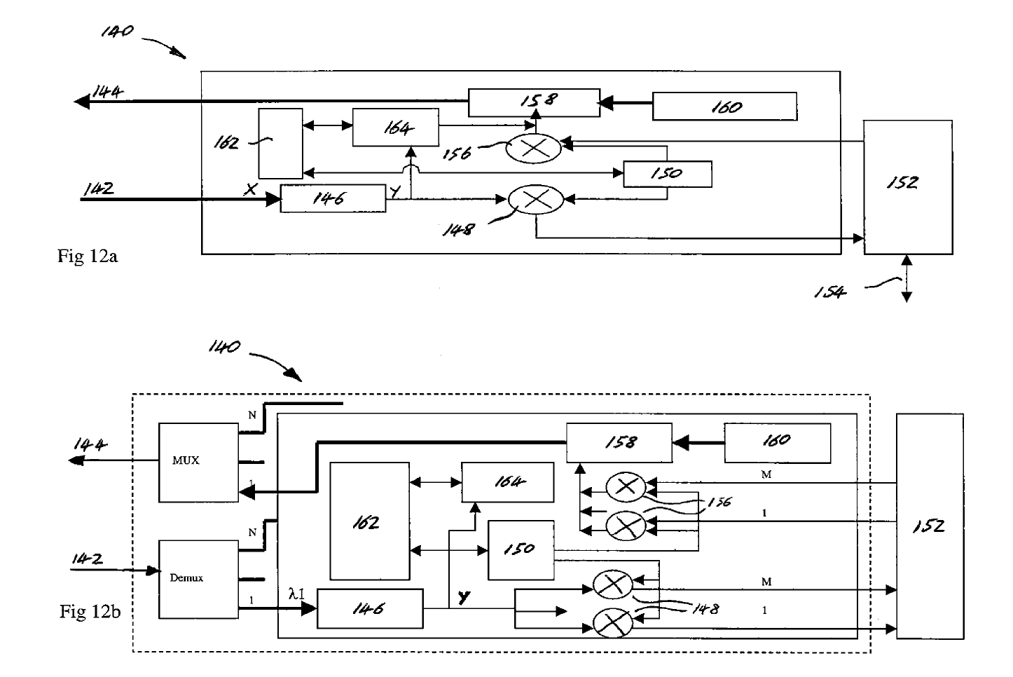

FIG. 12 shows a diagrammatic representation of a SCM sub-module.

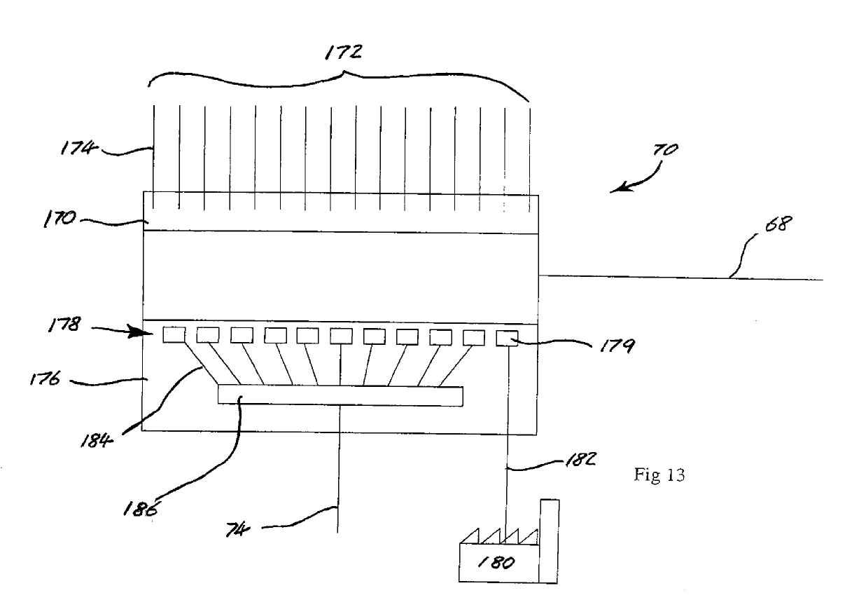

FIG. 13 shows a diagrammatic representation of how the secondary POP 70 of FIG. 6 is configured.

FIGS. 1-5 show diagrammatic representations of four stages of a telecommunications network for a metropolitan area according to an aspect of the present invention, generally designated 10. The four stages show how the architecture of the network 10 is changed over, for example, a 20-year life of the network 10 to improve data handling capacity. In particular FIGS. 2, 3, 4 and 5 illustrate how the architecture of the network 10 is changed over 3 years, 7 years, 11 years and 15 years respectively as the network architecture is changed from being a combination of copper and optic fibre, into being entirely optic fibre.

In FIG. 1 the network 10 is nominally laid onto a square grid 12 of side A having a dimension of 12 km and representing a metropolitan area. The grid 12 is subdivided into nine equally sized squares 14, each square 14 of side B having a dimension of 4 km. Each square 14 represents a local area of 384 users. A Point of Presence (POP) 16 is located at the centre of the grid 12. The POP 16 is a node, or a main telephone exchange of a conventional WDM optical network. The WDM network may operate using Dense WDM (DWDM) or Coarse WDM (CWDM) or any other technique for transmitting multiple lambdas simultaneously over a single fibre such as Optical Core Division Multiplexing (OCDM). By DWDM is meant transmitting with for example 200 GHZ, 100 GHz, 50 GHz or 25 GHz wavelength spacing, and by CWDM is meant transmitting with for example 2500 GHz wavelength spacing. The POP 16 serves a respective Passive Optical Network (PON) in each of the squares 14 via a respective optic fibre bundle 18. Each optic fibre bundle 18 comprising twenty-four individual optic fibres and in the first stage of the network 10 only one optic fibre of each optic fibre bundle 18 is used. The remaining optic fibres in each of the optic fibre bundles 18 are redundant in the first stage.

In this specification a PON is defined as being an optical network where there is no optical amplification for transmission of optical signals through the optical network. This means that there are no active electronic parts for optical amplification purposes. It will be appreciated that whilst such a PON has no electrical power requirements for optical amplification purposes there may well be components within the PON which do require electric power for their operation.

For simplicity the detailed architecture for only one square 14 is described in FIGS. 2-5. In FIG. 2 the POP 16 is shown in communication with an optical splitter 20 via one optic fibre in the optic fibre bundle 18. Such an optical splitter may for example be a WDM demultiplexer. The optical splitter 20 may be any optical splitter such as a DWDM demultiplexer. The optical splitter 20 is in turn in communication with Optical Network Units (ONUs) 22, 23, 24. Using such an optical splitter 20 permits the ONUs 22, 23, 24 to be located at different geographical locations such that in FIG. 2 the ONUs 22, 24 are at one location and the ONU 23 is at a different location. The optical splitter 20 has the capability to communicate with up to sixteen ONUs but for illustration purposes only three are shown in FIG. 2. The optical splitter 20 communicates with each ONU 22, 23, 24 via a respective optic fibre 25, 26, 28. The respective optic fibres 26, 28 are two individual fibres in an optic fibre bundle 27, and the respective optic fibre 25 is an individual fibre of a different optic fibre bundle. The bundles comprise twenty-four optic fibres so that there are a plurality of redundant optic fibres in the first stage of the network. In the example shown the ONU 22 is in communication with a series of six homes 30 via respective optic fibres 32, the ONU 24 is shown in communication with a series of four homes 34 via respective copper wires 36, and the ONU 23 is in communication with a series of four homes via respective optic fibres 37. It will be appreciated that each ONU 22, 23, 24 has the capability to communicate with up to twenty-four homes using CWDM but for simplicity only fourteen homes 30, 34, 35 are shown. The network connections to the homes 30, 34, 35 are made using star topology and in this manner the optical splitter 20 has the capability to supply 16×24=384 users with an average data carrying capacity of 50-100 Mb/s. In FIG. 2 it can be seen that the network 10 has the capability to supply bandwidth to users via optic fibres 32, 37 and copper wires 36.

Turning now to FIG. 3 there is shown a detailed diagrammatic representation of the network of FIG. 2 in a second stage. In FIG. 3 a third ONU 38 has been incorporated into the network architecture which is in communication with the optic splitter 20 via a respective optic fibre 40. The optic fibre 40 is an optic fibre from the optic fibre bundle 27 of twenty-four optic fibres so that only twenty-one optic fibres are now redundant. The series of six homes 30 of FIG. 2 are split into two series of three homes 42, 44 in FIG. 3. The ONU 22 communicates with the three homes 42 via respective optic fibres 32, and the ONU 38 communicates with the homes 44 via respective optic fibres 46 which are a sub-section of the optic fibres 32 of FIG. 2. In the example shown in FIG. 3 the network 10 permits coexistence of optic fibres 32, 37, 46 and copper wire 36 so that the ONU 24 still communicates with the homes 34 via copper wires 36.

In FIG. 3 it is shown that the number of homes per ONU that are supplied via an optic fibre has decreased so that the respective bandwidth to each home can be increased. The optic fibres 32, 46 remain in place and only central locations such as the ONUs 22, 24, 38 are required to be upgraded. The sub-set of optic fibres 46 are merely required to be connected to the new ONU 38. Such upgrading can be achieved because star topology is used throughout the network 10. In this manner the network 10 can be upgraded over time without requiring further optic fibre bundles or single optic fibres to be deployed and thereby saving the cost and disruption of road excavation. FIG. 3 shows that the bandwidth per household of the homes 42, 44 has been increased to 100-200 Mb/s.

Now turning to FIG. 4 there is shown a detailed diagrammatic representation of the network of FIG. 3 in a third stage. In FIG. 4 the series of homes 34 previously connected with copper wire 36 are now connected to the ONU 24 with optic fibres 48. In the third stage the optic fibres are laid and connected as the network 10 is gradually upgraded to an entirely fibre based architecture. In this manner all of the copper cables 36 within the network 10 are gradually decommissioned. During this transitional period the POP 16 may provide bandwidth to homes in other squares 14 using a combination of copper wires and optic fibres.

In FIG. 5 a detailed diagrammatic representation of the network of FIG. 4 is shown in a fourth stage. In FIG. 5 the network 10 is an entirely fibre based architecture whereby no copper wires 36 exists in the network 10 for supplying bandwidth to users. This leads to an overall reduction of the operational expenditure due to an overall simplification and unification of the network 10.

FIG. 5 also represents a layering stage of the network 10 whereby the part of the network downstream of the optical splitter 20 illustrated at 50 can be replicated in each square 14 to cope with additional users of the network over time. Each part of the network 50 is fed by a respective optic fibre from the optic fibre bundle 18. This may also require an additional POP 16 to supply the required bandwidth. In each new part of the network 50 new local optic fibres are required to be laid which may require road excavation. However, since the optic fibre bundle 18 is already present in the ground, part of the cost and disruption of further road excavation is avoided.

It will be appreciated that the single optic fibres 32, 46, 48 shown in FIGS. 2-5 may be substituted by an optic fibre pair for unidirectional or bi-directional communication as required.

The two main costs associated with deploying the network 10 are capital expenditure and operational expenditure. The capital expenditure includes the initial cost of equipment such as the optic fibres, the PONs and the POP 16. The cost associated with laying the optic fibre such as excavating roads and routing fibres through the metropolitan area is also included in the capital expenditure. The operational expenditure includes the costs associated with maintaining the PONs and the POP 16.

One of the advantages of the network 10 is that the overall capital expenditure and operational expenditure is kept to a minimum. An advantage of using PON technology is that because it is fully passive it allows greater bandwidth over greater distances of up to 20 km whilst reducing the requirement for active amplification sites which keeps costs to a minimum. Using PON technology as described above permits the PON to support future higher speed whilst keeping costs and disruption to a minimum. This is achieved by reducing the number of users per PON over time to enable the bandwidth per user to be increased. Fixed sites such as the POP 16, the optical splitter 20 and the ONUs 22, 24, 38 are easily upgraded, whereas the redundancy in the optic fibre bundles 18, 27 provides ready bandwidth handling capacity as required. Consequently the overall cost of maintaining the network 10 over a predicted life of 20 years is reduced.

In FIGS. 6-10 there are shown a series of diagrammatic representations illustrating four stages of a telecommunications network for a metropolitan area according to a further aspect of the present invention, generally designated 60. The four stages show how the architecture of the network 60 is changed over, for example, a 20-year life of the network 60 to improve data handling capacity. In particular FIGS. 6, 7, 8 and 9 illustrate how the architecture of the network 60 is changed over 3 years, 7 years, 11 years and 15 years respectively as the network architecture is changed from being a combination of copper and optic fibre, into being entirely optic fibre.

In FIG. 6 the network 60 is nominally laid onto a square grid 62 of side A having a dimension of 12 km and representing a metropolitan area. The grid 62 is subdivided into nine equally sized squares 64, each square 64 of side B having a dimension of 4 km. Each square 64 represents a local area of 384 users. A primary Point of Presence (POP)

66 is located at the centre of the grid 62. The primary POP 66 is a node, or a main telephone exchange of a conventional WDM optical network. The primary POP 66 serves a respective Passive Optical Network (PON) in each of the squares 64 via a respective optic fibre bundle 68. Each optic fibre bundle 68 comprising a plurality of individual optic fibres and in the first stage of the network 60 only one optic fibre of each optic fibre bundle 68 is used. The remaining optic fibres in each of the optic fibre bundles 68 are redundant in the first stage. The primary POP 66 is connected via a respective single optic fibre in the feed optic fibre bundle 68 to a secondary POP 70, such as a Marconi Access Hub, in each of the squares 64. In the first stage of the network 60 the secondary POP 70 is configured to permit users to communicate with the primary POP 66 via a copper wire 72 and via a supply optic fibre 74. It will be appreciated that the copper wire may be any conductor i.e. metallic wire. Although only one copper wire 72 and supply optic fibre 74 is shown, in practice there may well be a plurality of copper wires 72 and supply optic fibres 74. Each of the copper wires 72 may be connected to a plurality of users. Each of the supply optic fibres 74 is in communication with a PON, the detailed description of which will be provided below. Each secondary POP 70 on the grid 62 is configured in a similar manner. The details of how the secondary POP 70 is configured will be described in greater details in FIG. 13.

Now turning to FIG. 7 there is shown a diagrammatic representation of the network of FIG. 6 in a second stage. In FIG. 7 an optic fibre splice 76 has been included to directly connect the single fibre of the feed optic fibre bundle 68 with the supply optic fibre 74. The splice 76 bypasses the secondary POP 70 so that the PON downstream of the supply optic fibre 74 is backhauled to the primary POP 66. It will be appreciated that in practice a plurality of splices are required between each of the plurality of supply optic fibres 74 and a redundant fibre in the feed optic fibre bundle 68. In the second stage shown in FIG. 7 the secondary POP 70 still permits communication via the copper wires 72.

FIG. 8 shows a diagrammatic representation of the network of FIG. 7 in a third stage. In FIG. 8 the secondary POP 70 and the copper wires 72 have been removed as they gradually become redundant, and as the fibre architecture of the network 60 gradually migrates towards being completely fibre based. This stage of the network represents a significant reduction in the overall amount of equipment such as secondary POPs 70 in the network 60 with a consequent reduction in the operational and capital costs. It is envisaged that by the time that the third stage is reached in approximately 11 years time the electronics and the optics technologies will have matured to a point where the PONs served by supply optic fibre 74 will be able to be connected directly to the primary POP 66 via the splice 76. In this stage of the network it will be appreciated that there may well be other squares 78 where the respective secondary POP 80 is still in use. FIG. 9 shows the fourth stage of the network 60 whereby there are no secondary POPs 70, 80 in the grid 62 and the fibre architecture of the whole network 60 is entirely fibre optic based.

FIG. 10 is a detailed diagrammatic representation of the fibre architecture in the fourth stage of the network 60 shown in square 64 of FIG. 9. In FIG. 10 the primary POP 66 of FIG. 9 is shown in communication with an optical splitter 82 via the single optic fibre in the feed optic fibre bundle 68. A suitable optical splitter 82 for the downstream direction is a DWDM demultiplexer which is capable of demultiplexing multiple lambdas from B₁-Bₙ. It will be appreciated that in the upstream direction a DWDM multiplexer is used. The supply optic fibre 74 of FIG. 10 corresponds to the supply optic fibre 74 of FIG. 9. In FIG. 10 the optical splitter 82 supplies four optical fibre pairs 84, 86, 88, 90 with a respective lambda B₁, B₂, B₃, B₄. The optic fibre pair 88 is in direct communication with a business premises 92 and can supply up to 12 GHz of bandwidth. The optical fibre pair 84 is in communication with a secondary optical splitter 94 which is in turn in communication with 3 homes 96 via respective supply optical fibre pairs 98, 100, 102. It can be seen that the network connections to the business premises 92 and to the homes 96 are made using star topology. It is estimated that the overall reduction in optical intensity from the POP 66 to the homes 96 would be in the region of 20 dB. By using a Sub Carrier Multiplexing (SCM) technique each of the optic fibres 98, 100, 102 are provided with a respective sub-lambda B_{1,1}, B_{1,2} and B_{1,3} to supply up to 1.5 GHz of bandwidth to each home 96. Each sub-lambda B_{1,1}, B_{1,2} and B_{1,3} represents a respective channel. The optical splitter 94 broadcasts the entire bandwidth to the homes 96 and by using the SCM technique each home 96 sees the entire bandwidth B₁ but tunes in to transmit and receive a channel specific to that home. The details of how the homes 96 tune into a particular channel for receiving and transmitting are explained in FIGS. 11 and 12.

FIG. 11 shows a diagrammatic representation of a user connection terminal according to a further aspect of the present invention, generally designated 110. It is intended that one terminal 110 is located in each home 34, 42, 44 of the network 10 of FIGS. 2-5, and in each business premises 92 and home 96 of the network 60 of FIG. 10. In FIG. 11 the terminal 110 is provided with an input optic fibre 112 and an output optic fibre 114, although it will be appreciated that a terminal 110 having one fibre for inflow and outflow of data also falls within the scope of the invention. Utilisation of an optic fibre pair minimises the cost of the overall fibre architecture of the networks 10, 60. In the example of FIG. 11 one optic fibre pair 112, 114 represents a respective optic fibre connection 32, 46, 48 of FIG. 5, and a respective supply optic fibre pair 98, 100, 102 of FIG. 10. The terminal 110 of FIG. 11 is intended to bring the optic fibre connection directly into the user's premises to maximise bandwidth carrying capacity. It is intended that once a home 34, 42, 44, 96 or premises 92 is provided with an optic fibre connection it will also be provided with a terminal 110 as the networks 10, 60 are upgraded.

In FIG. 11 optical signals are indicated with bold arrows, and electrical signals are indicated with thin arrows. The input fibre 112 is for inflow of data to the terminal 110, and the output fibre 114 is for outflow of data from the terminal 110. The input fibre 112 is in communication with an integrated receiver 116 which incorporates a photodiode to translate the incoming optical signal X into a radio frequency electrical signal at Y. The electrical signal Y then passes to an input Radio Frequency (RF) mixer 118 which is adjusted by a programmable oscillator 120 to select a particular channel which has been allocated to a particular user by the network operator. The input RF mixer 118 outputs to an interface 122 which communicates at 124 via any of copper wire, optic fibre, radio or infra-red using a user commodity unit 126, more commonly termed a user commodity box. It is also envisaged that where the communication at 124 is by a wireless technology the terminal 110 could be located outside of the users home 96 or business premises 92 such as on a lamp post to avoid the requirement to bring a hard wire cable or optic fibre into the premises 92 or the home 34, 35, 42, 44, 96. Such a lamp post mounted terminal 110 would be configured to permit the use of mobile phone access technologies.

The user commodity box 126 of FIG. 11 forms the final interface with the user and permits the user to communicate with the terminal 110. The user commodity box 126 is the only part of the terminal 110 which is service and protocol specific using, for example the Ethernet protocol. The interface 122 communicates with an output RF mixer 128 which is adjusted by the programmable oscillator 120. The output RF mixer 128 and the input RF mixer ensure that the user of the terminal 110 only tunes into a particular channel of the available bandwidth so that unwanted channels are filtered from the required channel. In this way the terminal 110 can be thought of as a filtering device. The output RF mixer 128 outputs to an optical modulator 130 which is powered by a stabilised laser 132 to output an optical signal Z via the output fibre 114. The programmable oscillator 120 is also in two-way communication with a microprocessor 134 which is in turn in two-way communication with a service and communication channel 136. The service and communication channel 136 outputs to the optical modulator 130 and permits the telephone company to determine faults with the terminal 110 or user commodity box 126, or to determine whether the terminal 110 has been tampered with.

Whilst the user commodity box 126 of FIG. 11 is primarily Ethernet based it is envisaged that it could further be adapted for use with for example radio, infra-red, wireless, copper cable or future mobile network access technologies. The user commodity box 126 may be required to be upgraded over time but it is intended that the remainder of the terminal 110 is untouched from the day of installation. It is envisaged that the terminal 110 and/or the user commodity box 126 is powered locally which is a major departure from the current trend in the telecommunications industry. For example, at present land line telephones receive their power via the network cable which carries the telecommunications signal. It is also envisaged that the terminal 110 and/or the user commodity box 126 is at least partially owned by the user.

In an alternative arrangement the user connection terminal 110 can be located in a street location such as on a lamp post. In this arrangement each user may connect to the user connection terminal 110 via radio, copper, fibre or free space optics. Typically the final connection from the lamp post to the user's premises will be in the range 100 m-300 m. It is envisaged that the user connection terminal 110 will be able to draw its power from the lamp post itself. It will be appreciated that in this alternative arrangement there are as many upstream optical sources (equating to the laser 132 of FIG. 11) as there are end users. All lasers 132 in the upstream direction in the arrangement of FIG. 11 and in the alternative arrangement may require frequency and phase stabilisation and the skilled person will know the arrangements for providing these features such as by using locked lasers 132.

Now turning to FIG. 12 there is shown a diagrammatic representation of a SCM sub-module, generally designated 140. In FIG. 12a the sub-module 140 is embodied as a sub-card in a item of telecoms equipment located at a central office, and is configured to communicate with the terminal 110 of FIG. 11 such that one sub-module 140 is required for each user of the network. In FIG. 12 the sub-module 140 is provided with an input optic fibre 142 and an output optic fibre 144, although it will be appreciated that a sub-module 140 having one fibre for inflow and outflow of data also falls within the scope of the invention. In the example of FIG. 12 one optic fibre pair 142, 144 represents a respective optic fibre connection 26, 28 of FIG. 2, and a respective optic fibre pair 142, 144 supplies a respective four optical fibre pairs 84, 86, 88, 90 of FIG. 10.

In FIG. 12 optical signals are indicated with bold arrows, and electrical signals are indicated with thin arrows. The input fibre 142 is for inflow of data to the sub-module 140, and the output fibre 144 is for outflow of data from the module 140. The input fibre 142 is in communication with an integrated receiver 146 which incorporates a photodiode to translate an incoming optical signal X, such as a single frequency λ, into a radio frequency electrical signal at Y. The electrical signal Y then passes to an input Radio Frequency (RF) mixer 148 which is adjusted by a programmable oscillator 150 to select a particular channel which has been allocated to a particular user by the network operator. The input RF mixer 148 outputs to a sub-module commodity box 152 which communicates at 154 with a PON subsection card (not shown) of the secondary POP 70. The sub-module commodity box 152 communicates with an output RF mixer 156 which is adjusted by the programmable oscillator 150. The sub-module commodity box 152 mirrors the user commodity box 126 of FIG. 11. The output RF mixer 156 and the input RF mixer 148 ensure that the sub-module 140 only tunes into a particular channel of the available bandwidth which corresponds to the channel used by the terminal 110 of FIG. 11 for a particular user. In FIG. 12 the output RF mixer 156 outputs to an optical modulator 158 which is powered by a stabilised laser 160 to output an optical signal Z via the output fibre 144. The programmable oscillator 150 is also in two-way communication with a microprocessor 162 which is in turn in two-way communication with a service and communication channel 164. The service and communication channel 164 outputs to the optical modulator 158 and permits the telephone company to determine faults with the terminal 110 of FIG. 11. The sub-module 140 of FIG. 12 may be required to be upgraded over time.

In an alternative arrangement shown in FIG. 12b the integrated receiver 146 incorporates a wideband photodiode to translate the incoming optical signal λ that has been separated by the DWDM demux into an aggregate radio frequency signal Y further separated by a bank of mixers 148 and extracted using the multi-programmable oscillators 150 to select the particular sub-channel allocated by the particular user by the network operator. The transparent signals are fed to the protocol specific card section 152 onto the central office equipment. Similarly the downstream signals are allocated to users in sub-channels by using the bank of mixers 156 which are added and fed to the optical modulator 158 that modulates the light of the stabilised laser 160 at the correct frequency. The optical signal is further aggregated by means of the DWDM multiplexer and fed downstream by means of the downstream PON main fibre 144 towards the downstream DWDM splitter 82 of FIG. 10.

Turning now to FIG. 13 there is shown a diagrammatic representation of how the secondary POP 70 of FIG. 6 is configured in the downstream direction. In FIG. 13 the secondary POP 70 is in communication with the primary POP 66 of FIG. 6 via a single optic fibre in the feed optic fibre bundle 68. The secondary POP 70 of FIG. 13 has a first card 170 which communicates with users 172 via copper wires 174. The secondary POP 70 also has a secondary card 176 which has a series of PONs 178. One of the PONs 179 is connected directly to a business premises 180 via optic fibre 182 to supply a large bandwidth as required. The remaining PONs of the series of PONs 178 are each connected via respective optic fibres 184 to a DWDM multiplexer 186. The DWDM multiplexer 186 communicates via the supply optic fibre 74 which corresponds to the supply optic fibre of FIG. 10. The details of how the cards 170, 176 are configured are well known to the person skilled in the art and are not described further. It will be appreciated that a similar arrangement is required in the upstream direction although a DWDM demultiplexer (not shown) is required in place of the DWDM multiplexer 186.

The SCM technique which utilises the terminal 110 and sub-module 140 provides the necessary privacy to permit further splitting to be achieved. In this manner it can be seen that each user is provided with a unique point to point connection whilst increasing the bandwidth-distance product when compared to access via copper wires. Since the bandwidth-distance product is increased the number of central offices containing POPs 70, 80 of the network 60 can be reduced which in turn reduces the operational and capital expenditure of the network 60. Since the number of central offices are reduced the capacity of the remaining central offices will be required to be much greater than the current requirements. It is envisaged, however, that the switching capacity, level of optical integration and general processing power will increase over time as the capabilities of general technology improves over time. In this manner a key aspect of the invention is that it is aligned with the expected technology evolution of the key technologies involved.

The networks 10, 60 are intended to require minimal upgrading and maintenance over their projected 20-year life. A key factor in achieving this goal is to ensure that when initially installing the networks 10, 60 the optics such as the integrated receiver 116 in the terminal 110 incorporating the photodiode are capable of handling the very large predicted bandwidth at the end of the life of the networks 10, 60.

A network 10, 60 so arranged increases the bandwidth-distance product and enables the PON based architecture to be used more efficiently. Use of the networks 10, 60 and the terminal 110 permits a so-called transparent channel to be deployed that can be used to support many different services and network protocols. Since the channel is transparent is should be relatively independent of the equipment which is used with it, and hence the lifetime of the network 10, 60 and the terminal 110 should exceed a predicted lifetime of 20 years. The networks 10, 60 are capable of evolving over time and permit a gradual deployment and upgrading of optical equipment which has the effect of reducing the operational expenditure and the cost of ownership of the networks 10, 60.

1. A method of operating a telecommunications network comprising the steps of;
providing a primary point of presence of a wavelength division multiplexing optical network;
providing a secondary point of presence in communication with the primary point of presence via a single fibre of a feed optic fibre bundle;
providing a passive optical network downstream of the secondary point of presence; and
providing a copper cable connection downstream of the secondary point of presence,
wherein access to the network is provided via said passive optical network and via said copper cable.

2. A method of operating a telecommunications network according to claim 1 and further including the steps of;
providing a wavelength division multiplexing demultiplexer downstream of the secondary point of presence such that the passive optical network is downstream of the wavelength division multiplexing demultiplexer, and
providing an optical network unit downstream of the wavelength division multiplexing demultiplexer,
wherein the optical network unit is connected to users via a plurality of respective supply optical fibres.

3. A method of operating a telecommunications network according to claim 1 or claim 2 and further including the step of;
providing a plurality of passive optical networks downstream of the secondary point of presence.

4. A method of operating a telecommunications network according to claim 3 and further including the steps of;
providing each passive optical network with at least one optical network unit; and
configuring the at least one optical network unit to operate using sub-carrier multiplexing.

5. A method of operating a telecommunications network according to any preceding claim and further including the steps of;
providing a splice optic fibre; and
bypassing the secondary point of presence with the splice optic fibre so that at least one passive optical network downstream of the splice is backhauled to a respective feed optic fibre of the feed optic fibre bundle.

6. A method of operating a telecommunications network according to any preceding claim and further including the steps of;
decommissioning the secondary point of presence and the copper cable connection.

7. A user connection terminal provided with at least one optic fibre for inflow and outflow of data, the terminal comprising a receiver in communication with the optic fibre, the receiver being adapted for translating an input optical signal into an electrical signal, the receiver adapted for communication with a user commodity unit, in use, which in turn is adapted to transmit an output electrical signal to an optical modulator for translation of the output electrical signal into an output optical signal for transmission via the optic fibre, wherein a user interacts with the terminal via said user commodity unit.

8. A user connection terminal according to claim 7 and being provided with an input optic fibre and an output optic fibre for inflow and outflow of data respectively, the input optic fibre in communication with the receiver, and the output optic fibre in communication with the optical modulator.

9. A user connection terminal according to claim 7 or claim 8 wherein the electrical signals are radio frequency electric signals.

10. A user connection terminal according to claim 9 wherein the input electrical signal is passed to an input radio frequency mixer which is tuned to a sub-carrier frequency using a programmable oscillator.

11. A user connection terminal according to claim 10 wherein the input radio frequency mixer outputs to an interface which in turn communicates with the user commodity unit.

12. A user connection terminal according to claim 11 wherein communication between the interface and the commodity unit is primarily Ethernet based.

13. A user connection terminal according to claim 11 or claim 12 wherein the interface communicates with an output radio frequency mixer which is tuned to the same frequency as the input radio frequency mixer by the programmable oscillator.

14. A user connection terminal according to claim 13 wherein the output radio frequency mixer communicates with the optical modulator.

15. A user connection terminal according to any of claims 10-14 wherein the terminal is powered locally at the user's premises.

16. A user connection terminal according to any of claims 10-15 wherein the programmable oscillator is in two-way communication with a microprocessor which is in turn in two-way communication with a service and communication channel which in turn outputs to the optical modulator.

17. A user connection terminal according to claim 16 and being provided with a sub-module which corresponds to the user connection terminal, the sub-module being located at a point of presence and being configured to communicate with the user connection terminal to permit a user to connect to the network.

18. A user connection terminal according to claim 17 wherein the sub-module is provided with an optic fibre for inflow and outflow of data to the sub-module, the sub-module comprising a sub-module receiver to translate an incoming optical signal into an input electrical signal, the input electrical signal being input to a sub-module commodity unit, the sub-module commodity unit communicating, in use, with the upstream network, data flowing downstream from the sub-module commodity unit being translated into an output electrical signal and being input to a sub-module optical modulator for translation into an output optical signal for transmission via the optic fibre.

19. A user connection terminal according to claim 18 wherein there is provided an input optic fibre and an output optic fibre for inflow and outflow of data to the sub-module respectively, the input optic fibre in communication with the sub-module receiver, and the output optic fibre in communication with the sub-module optical modulator.

20. A user connection terminal according to claim 18 or claim 19 wherein the electrical signals are radio frequency electric signals.

21. A user connection terminal according to claim 20 wherein the input electrical signal is input to an input radio frequency mixer which is tuned by a sub-module programmable oscillator to the same sub-carrier frequency as the user connection terminal.

22. A user connection terminal according to claim 21 wherein the input radio frequency mixer is in communication with the sub-module commodity unit.

23. A user connection terminal according to claim 21 or claim 22 wherein the sub-module commodity unit communicates with an output radio frequency mixer which is tuned to the same frequency as the input radio frequency mixer by the sub-module programmable oscillator.

24. A user connection terminal according to claim 23 wherein the output radio frequency mixer outputs to the sub-module optical modulator.

25. A user connection terminal according to any of claims 21-24 wherein the sub-module programmable oscillator is in two-way communication with a sub-module microprocessor which is in turn in two-way communication with the service and communication channel which in turn outputs to the sub-module optical modulator.

26. A user connection terminal according to any of claims 7-25 wherein the commodity unit is adaptable for communication with a wireless access technology.

27. A user connection terminal according to claim 26 wherein the wireless access technology is selected from radio, infra-red and mobile phone.

28. A user connection terminal according to any of claims 7-25 wherein the commodity unit is adaptable for communication with any of copper wire and optic fibre.

29. A method of operating a passive optical network comprising the steps of;
providing a feed optic fibre bundle in communication with a wavelength division multiplexing optical network;
providing an optical splitter in communication with an optic fibre in the feed optic fibre bundle;
providing a connecting optic fibre in communication with the optic splitter;
providing an optical network unit in communication with the connecting optic fibre; and
providing a supply optic fibre in communication with the optical network unit, the supply optic fibre being adapted for communication with a user of the network,
wherein the feed optic fibre bundle has a plurality of redundant optic fibres.

30. A method according to claim 29 and further including the step of;
reducing the number of users per optical network unit over time to enable an increased bandwidth per user to be provided over time.

31. A method according to claim 29 of claim 30 and further including the step of;
providing a user connection terminal at the location of each user of the network to permit the user to connect to the network by optic fibre, in use.

32. A method according to any of claims 29-31 and further including the step of;
arranging the network as a plurality of cells, wherein each cell is supplied with a respective feed optic fibre bundle.

33. A method according to any of claims 29-32 and further including the step of;
providing a connecting optic fibre bundle, the connecting optic fibre comprising an optic fibre in the connecting optic fibre bundle.

34. A method according to any of claims 29-33 and further including the step of;
providing a plurality of supply optic fibres, one supply optic fibre for each user of the network, wherein each supply optic fibre is connected to the optical network unit.

35. A method according to any of claims 29-34 and further including the step of;
providing a copper cable in communication with the optical network unit wherein the copper cable is connected with a user of the network.

36. A method according to claim 35 and further including the step of;
providing a plurality of copper cables, one copper cable for each user of the network wherein each copper cable is connected to the optical network unit.

37. A method according to claim 35 or claim 36 and further including the step of;
replacing the copper cables with optic fibres.

38. A method according to any of claims 29-37 wherein the optic fibre bundles contain up to 200 optic fibres.

39. A passive optical network comprising a feed optic fibre bundle in communication with a wavelength division multiplexing optical network, an optical splitter in communication with an optic fibre in the feed optic fibre bundle, a connecting optic fibre in communication with the optic splitter, an optical network unit in communication with the connecting optic fibre, and a supply optic fibre in communication with the optical network unit, the supply optic fibre being adapted for communication with a user of the network, wherein the feed optic fibre bundle has a plurality of redundant optic fibres.

40. A passive optical network according to claim 39 wherein the network further includes a connecting optic fibre bundle, the connecting optic fibre being an optic fibre in the connecting optic fibre bundle.

41. A passive optical network according to claim 39 or claim 40 wherein a plurality of supply optic fibres are provided, one feed optic fibre for each user of the network, wherein each feed optic fibre is connected to the optical network unit.

42. A passive optical network according to claim 39, 40 or claim 41 and further including a copper cable in communication with the optical network unit wherein the copper cable is in communication with a user of the network.

43. A passive optical network according to claim 42 and further including a plurality of copper cables, one copper cable for each user of the network wherein each copper cable is connected to the optical network unit.

44. A passive optical network according to any of claims 39-43 wherein the network is arranged as a plurality of cells, each cell being supplied with a respective feed optic fibre bundle.

45. A passive optical network according to any of claims 39-44 wherein the optic fibre bundles contain up to 200 optic fibres.

46. A passive optical network according to any of claims 39-45 and further including a user connection terminal at the location of each user of the network for connection to the network by optic fibre.

47. A passive optical network according to any of claims 46 wherein the respective supply optic fibre is adapted to handle both inflow and outflow of data to the user connection terminal.

48. A passive optical network according to claim 46 of claim 47 the terminal is provided with an input optic fibre and an output optic fibre for inflow and outflow of data to the terminal respectively, the input optic fibre and output optic fibre in communication with the optical network unit.

49. A passive optical network according to claim 48 wherein the user connection terminal comprises a receiver in communication with the input optic fibre, the receiver being adapted for translating an input optical signal into an electrical signal, the electrical signal being input to a user commodity unit in use which in turn is adapted to communicate with an optical modulator for translation of the electrical signal into an output optical signal for transmission via the output optic fibre, such that a user interacts with the terminal via said user commodity unit.

50. A passive optical network according to claim 49 wherein the electrical signal is a radio frequency electric signal.

51. A passive optical network according to claim 49 or claim 50 wherein the commodity unit is primarily Ethernet based.

52. A passive optical network according to claim 49, 50 or claim 51 wherein the commodity unit is adaptable for communication with a wireless access technology.

53. A passive optical network according to claim 52 wherein the wireless access technology is selected from radio, infra-red and mobile phone.

54. A passive optical network according to claim 51 wherein the commodity unit is adaptable for communication with any of copper wire and optic fibre.

55. A passive optical network according to any of claims 46-54 wherein the terminal is powered locally at the user's premises.
